(19) United States
(12) Patent Application Publication
(10) Pub. No.: US 2010/0270404 A1
(43) Pub. Date: Oct. 28, 2010

(54) TYPE PROTECTION DEVICE FOR SHREDDERS

(75) Inventor: Xinxiong Chen, Shanghai (CN)

Correspondence Address: BANNER & WITCOFF, LTD., 1100 13th STREET, N.W., SUITE 1200, WASHINGTON, DC, 20005-4051, US

(73) Assignee: AURORA OFFICE EQUIPMENT CO., LTD. SHANGHAI, Shanghai (CN)

(21) Appl. No.: 12/509,730

(22) Filed: Jul. 27, 2009

(30) Foreign Application Priority Data
Apr. 28, 2009 (CN) 200910050122.0

(51) Int. Cl. B02C 23/00

(52) U.S. Cl. 241/36

(57) ABSTRACT

The present invention relates to a new type protection device for shredders which comprises a paper number detecting device mounted at the paper inserting passage of the shredder, a warning device mounted on the shredder and a controlling device in line connection with the paper number detecting device and the warning device respectively, mounted in the shredder and in line connection with the driving component of the shredder driving the shredder blades, preferably the protection device further comprises an insert detecting device in line connection with the controlling device and mounted at the paper inserting passage, and at least one opaque shielding component mounted at the paper inserting passage and at the middle of which there is at least one slot along the length direction, the present invention controls the number of the paper to be shredded during the paper inserting stage, and shreds paper automatically only in a predetermined value range, to avoid abnormalities that result in failure of the machine such as jam and tooth breaking when the shredder is shredding many pieces of paper, so as to reduce maintenance times and cost, extend service life, and make application of shredders safer and more reliable, more convenient and simpler, then to achieve better protection of shredders.

### TECHNOLOGY FIELD

The present invention relates to the field of shredders, especially to the field of protection devices of shredders, in particular to a new type protection device for shredders.

### BACKGROUND TECHNOLOGY

At present, the frame chart of the circuit of one protection device of commercially available shredders used commonly is shown in FIG. 1, the cutting blades, the driving gears and the motor of the shredder core are in charge of shredding the paper fed into, the main control panel controls the operation of the motor and the protection functions of the overheat protection and the overload protection of the motor, detecting the paper fed into or the open or close of the door of the trash can, and so on, and the corresponding indicator (LED) or LCD on the surface of the upper cover reminds the user to clear trouble before the working of the shredder, so its key protection function is to enable the motor and the driving gears to run smoothly.

One basic working principle of the above protection device is to utilize the reaction force of many pieces of paper to be shredded after they are fed into the cutting blades to force the motor of the shredder to be unable to rotate due to insufficient torsion, so as to make the current value of the sampling resistance or coil in tandem in the circuit exceed the predetermined value of the shredder control circuit, then to stop the working of the motor to protect the motor and driving gears.

Another basic working principle of the above protection device is to utilize a coded disc mounted at the end of the motor shaft to detect the rotational speed of the shredder motor decreased due to insufficient torsion resulting from the reaction force of many pieces of paper to be shredded after they are fed into the cutting blades, so as to control the motor to stop through the control circuit of the shredder to protect the motor and driving gears.

Because the above protection devices both are to stop the motor when the motor decelerates or can not rotate completely, so as to protect the motor and driving gears, and at that time the motor has been under the overload operation, that such process occurs many times would undoubtedly result in the failure of the motor or breaking the driving gears, to make the machine can not work completely. These problems are main puzzles that cause shredders to be repaired frequently and used inconveniently by users.

In order to solve the above existing problems and shortcomings, it is very necessary to improve further, even innovate the protection device of common shredders.

### DISCLOSURE OF THE INVENTION

Aspects of the present invention generally pertain to a new type protection device for shredders, that new type protection device for shredders controls the number of the paper to be shredded during the paper inserting stage, and shreds paper automatically only in a predetermined value range, to avoid abnormalities that result in failure of the machine such as jam and tooth breaking when the shredder is shredding many pieces of paper, so as to reduce maintenance times and cost, extend service life, and make application of shredders safer and more reliable, more convenient and simpler, then to achieve better protection of shredders.

In order to realize the above aims, in a first aspect of the present invention, a new type protection device for shredders is provided. In an aspect, the new type protection device for shredders comprises:

a paper number detecting device, mounted at the paper inserting passage of the shredder, and detecting the number of the paper inserted into the paper inserting passage;

a warning device, mounted on the shredder and warning the user;

a controlling device, in line connection with the paper number detecting device and the warning device respectively, mounted in the shredder and in line connection with the driving component of the shredder driving the shredder blades, for controlling the driving component and the warning device respectively according to the detecting result of the paper number detecting device.

In a further aspect, the paper number detecting device is an optically controlled paper number detecting device.

In yet another aspect, the optically controlled paper number detecting device comprises an optical emitting component and an optical receiving component mounted respectively and oppositely at two relatively long sides of the paper inserting passage.

In yet another aspect, the optical emitting component and the optical receiving component are mounted at the middle parts of the two relatively long sides of the paper inserting passage respectively.

In yet another aspect, the optical emitting component is an optical emitting tube, and the optical receiving component is an optical receiving tube.

In yet another aspect, the optical emitting tube is an infrared ray emitting tube, a visible light emitting tube or an ultraviolet ray emitting tube, correspondingly the optical receiving tube is an infrared ray receiving tube, a visible light receiving tube or an ultraviolet ray receiving tube.

In a further aspect, the control center of the shredder and the controlling device are integrated as a whole.

In a further aspect, the warning device is an audible warning component or a light warning component.

In yet another aspect, the audible warning component is a loudspeaker, and the light warning component is a LED indicating lamp.

In a further aspect, the new type protection device for shredders further comprises an insert detecting device in line connection with the controlling device and mounted at the paper inserting passage of the shredder for detecting whether an insert in the paper inserting passage is paper or not, and the controlling device would control the startup of the paper number detecting device when the insert detected by the insert detecting device is paper.

In yet another aspect, the insert detecting device is mounted at the paper inserting passage and parallel to the paper number detecting device.

In yet another aspect, the insert detecting device is an optically controlled insert detecting device.

In yet another aspect, the optically controlled insert detecting device comprises an optical emitting piece and an optical receiving piece mounted respectively and oppositely at two relatively long sides of the paper inserting passage.

In yet another aspect, the optical emitting piece and the optical receiving piece are mounted at the middle parts of the two relatively long sides of the paper inserting passage respectively.

In yet another aspect, the optical emitting piece is an optical emitting pipe, and the optical receiving piece is an optical receiving pipe.

In yet another aspect, the optical emitting pipe is an infrared ray emitting pipe, a visible light emitting pipe or an ultraviolet ray emitting pipe, correspondingly the optical receiving pipe is an infrared ray receiving pipe, a visible light receiving pipe or an ultraviolet ray receiving pipe.

In a further aspect, the new type protection device for shredders further comprises at least one opaque shielding component at the middle of which there is at least one slot along the length direction, and the opaque shielding component(s) is(are) mounted at the paper inserting passage for shielding off beams and sundries.

In yet another aspect, the opaque shielding components the number of which is 2 are mounted at two ends of the paper inserting passage respectively.

In yet another aspect, the number of the slot in the opaque shielding component is 1, two ends of the opaque shielding component are separated from two relatively short sides of the paper inserting passage, and two sides of the opaque shielding component are fixed to the two relatively long sides of the paper inserting passage.

In yet another aspect, the opaque shielding component is a plastic film, a piece of paper, a metal sheet or a cloth strip.

In another aspect of the present invention, a new type protection device for shredders is provided, and comprises:

a paper number detecting device, mounted at the paper inserting passage of the shredder, and detecting the number of the paper inserted into the paper inserting passage;

a warning device, mounted on the shredder and warning the user;

an insert detecting device, mounted at the paper inserting passage of the shredder for detecting whether an insert in the paper inserting passage is paper or not;

a controlling device, in line connection with the paper number detecting device, the warning device and the insert detecting device respectively, mounted in the shredder and in line connection with the driving component of the shredder driving the shredder blades, for controlling the startup of the paper number detecting device when the insert detected by the insert detecting device is paper, and controlling the driving component and the warning device respectively according to the detecting result of the paper number detecting device; and

at least one opaque shielding component, at the middle of which there is at least one slot along the length direction, and mounted at the paper inserting passage for shielding off beams and sundries.

In a further aspect, the paper number detecting device is an optically controlled paper number detecting device.

In yet another aspect, the optically controlled paper number detecting device comprises an optical emitting component and an optical receiving component mounted respectively and oppositely at two relatively long sides of the paper inserting passage.

In yet another aspect, the optical emitting component and the optical receiving component are mounted at the middle parts of the two relatively long sides of the paper inserting passage respectively.

In yet another aspect, the optical emitting component is an optical emitting tube, and the optical receiving component is an optical receiving tube.

In yet another aspect, the optical emitting tube is an infrared ray emitting tube, a visible light emitting tube or an ultraviolet ray emitting tube, correspondingly the optical receiving tube is an infrared ray receiving tube, a visible light receiving tube or an ultraviolet ray receiving tube.

In a further aspect, the control center of the shredder and the controlling device are integrated as a whole.

In a further aspect, the warning device is an audible warning component or a light warning component.

In yet another aspect, the audible warning component is a loudspeaker, and the light warning component is a LED indicating lamp.

In a further aspect, the insert detecting device is mounted at the paper inserting passage and parallel to the paper number detecting device.

In a further aspect, the insert detecting device is an optically controlled insert detecting device.

In yet another aspect, the optically controlled insert detecting device comprises an optical emitting piece and an optical receiving piece mounted respectively and oppositely at two relatively long sides of the paper inserting passage.

In yet another aspect, the optical emitting piece and the optical receiving piece are mounted at the middle parts of the two relatively long sides of the paper inserting passage respectively.

In yet another aspect, the optical emitting piece is an optical emitting pipe, and the optical receiving piece is an optical receiving pipe.

In yet another aspect, the optical emitting pipe is an infrared ray emitting pipe, a visible light emitting pipe or an ultraviolet ray emitting pipe, correspondingly the optical receiving pipe is an infrared ray receiving pipe, a visible light receiving pipe or an ultraviolet ray receiving pipe.

In a further aspect, the opaque shielding components the number of which is 2 are mounted at two ends of the paper inserting passage respectively.

In a further aspect, the number of the slot in the opaque shielding component is 1, two ends of the opaque shielding component are separated from two relatively short sides of the paper inserting passage, and two sides of the opaque shielding component are fixed to the two relatively long sides of the paper inserting passage.

In a further aspect, the opaque shielding component is a plastic film, a piece of paper, a metal sheet or a cloth strip.

The beneficial effects of the present invention are as follows:

1. The paper number detecting device of the present invention is mounted at the paper inserting passage of the shredder, and controls the number of the paper to be shredded during the paper inserting stage, once the number exceeds the predetermined value, the warning device would warns the user till the user reduces the number of the paper to be in the predetermined value range, and the shredder shreds paper automatically in the predetermined value range, to avoid abnormalities that result in failure of the machine such as jam and tooth breaking when the shredder is shredding many pieces of paper, so as to reduce maintenance times and cost, extend service life, and make application of shredders safer and more reliable, more convenient and simpler, then to achieve better protection of shredders;

2. The paper number detecting device of the present invention in particular adopts the common opposite-type optical emitting and receiving tubes which are easy to obtain, and have a practical function

3. The insert detecting device of the present invention detects whether an insert in the paper inserting passage is paper or not, if so, the controlling device would control the startup of the paper number detecting device, if not, the insert would be shredded directly, all these processes are controlled automatically, thus the shredder can be used very conveniently.

4. The opaque shielding components of the present invention are mounted at the upper and lower ends of the paper inserting passage, have a simple structure, can shield off dusts and beams, and have many functions.

5. The present invention has a simple and quick working process and a simple circuit, and its functional modules can be directly planted into the existing machines and adjusted slightly, then the detection of different pieces of paper can be performed immediately, such as detecting 3, 5, 6, 8, 10, 12, 16, 18, 20 and 25 pieces of paper.

### DESCRIPTION OF THE FIGURES

FIG. 1 is a frame chart of the circuit of one protection device of commercially available shredders used commonly.

FIG. 2 is a partial cutaway schematic view of a shredder with one embodiment of the present invention.

FIG. 3 is a stereogram of the paper inserting opening assembly of the embodiment shown in FIG. 2.

FIG. 4 is a schematic view of the paper inserting opening assembly shown in FIG. 3 without the upper opaque shielding component.

FIG. 5 is another stereogram of the paper inserting opening assembly shown in FIG. 3.

FIG. 6 is a schematic view of the paper inserting opening assembly shown in FIG. 5 without the lower opaque shielding component.

FIG. 7 is a frame chart of the circuit of the new type protection device for shredders of the present invention.

FIG. 8 is a working process frame chart of the new type protection device for shredders of the present invention.

### PREFERRED EMBODIMENTS OF THE INVENTION

In order to understand the technical content of the present invention more clearly, the present invention would be exemplified further by reference to the following embodiments.

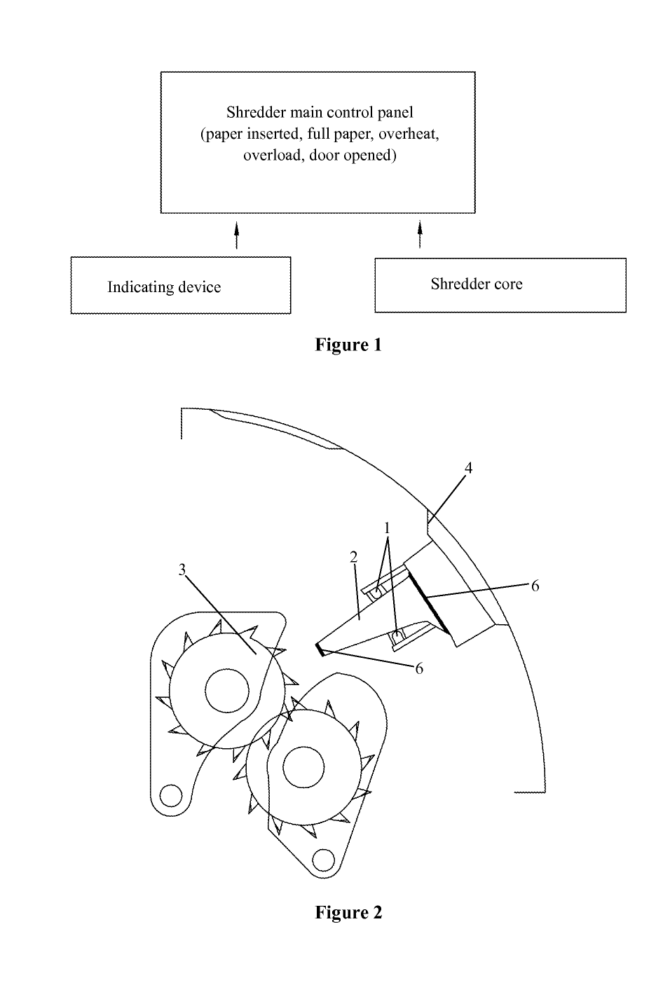

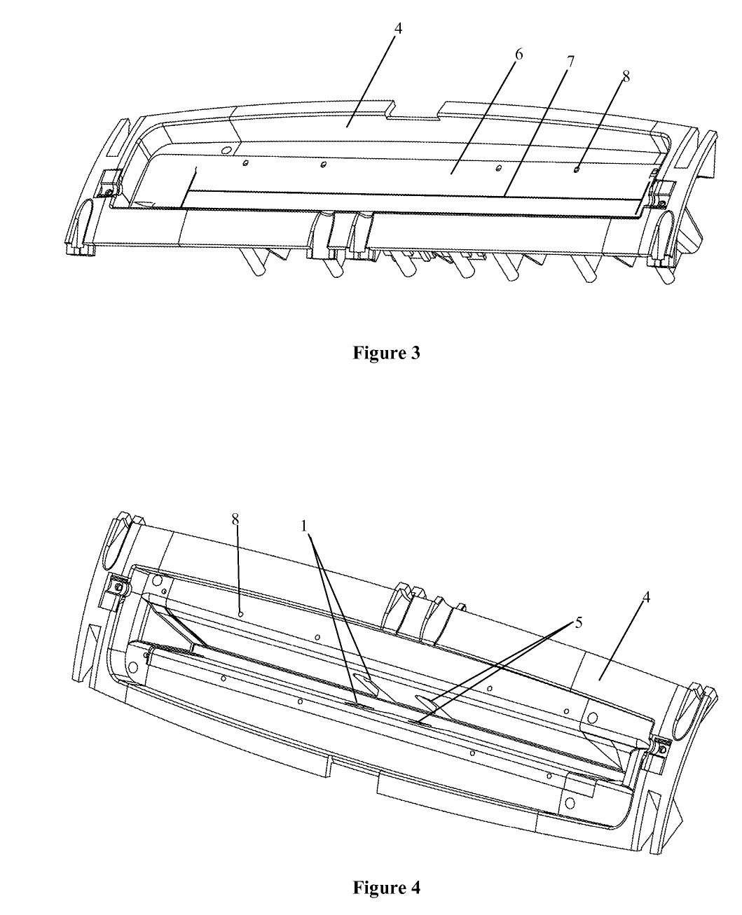

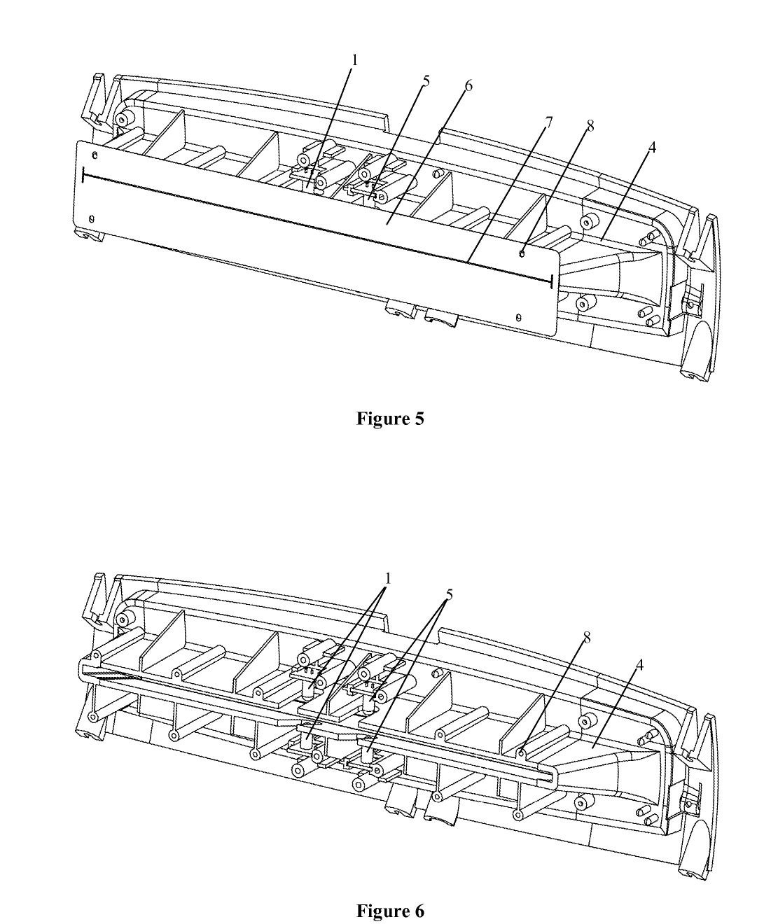

Please refer to FIG. 1-6, the new type protection device for shredders of the present invention comprises a paper number detecting device 1 mounted at the paper inserting passage 2 of the shredder and detecting the number of the paper inserted into the paper inserting passage 2; a warning device, mounted on the shredder and warning the user; and a controlling device in line connection with the paper number detecting device 1 and the warning device respectively, and mounted in the shredder and in line connection with the driving component of the shredder driving the shredder blades 3, for controlling the driving component and the warning device respectively according to the detecting result of the paper number detecting device 1.

In a further aspect, the paper number detecting device 1 is an optically controlled paper number detecting device.

In yet another aspect, the optically controlled paper number detecting device comprises an optical emitting component and an optical receiving component mounted respectively and oppositely at two relatively long sides of the paper inserting passage 2.

In one embodiment of the present invention, the optical emitting component and the optical receiving component are mounted at the middle parts of the two relatively long sides of the paper inserting passage 2 respectively.

In one embodiment of the present invention, the optical emitting component is an optical emitting tube, and the optical receiving component is an optical receiving tube. The optical emitting tube and the optical receiving tube utilize the different penetration rates of the optical wave to different pieces of paper to detect the number of paper, so the optical emitting tube is an infrared ray emitting tube, a visible light emitting tube or an ultraviolet ray emitting tube, correspondingly the optical receiving tube is an infrared ray receiving tube, a visible light receiving tube or an ultraviolet ray receiving tube. The optical emitting tube and the optical receiving tube of the present invention and the paper inserting opening assembly 4 can be a whole part or different parts. The outer diameters of the tubes are generally 3 mm or 5 mm, and there is no limitation to their colors.

In one embodiment of the present invention, the control center of the shredder and the controlling device are integrated as a whole.

In a further aspect, the warning device is an audible warning component or a light warning component.

In yet another aspect, the audible warning component is a loudspeaker, and the light warning component is a LED indicating lamp. In one embodiment of the present invention, the warning device is a red LED indicating lamp. The indicating lamp can be indicated by visual LCD symbols or inside sound generating devices.

In a further aspect, the new type protection device for shredders further comprises an insert detecting device 5 in line connection with the controlling device and mounted at the paper inserting passage 2 of the shredder for detecting whether an insert in the paper inserting passage 2 is paper or not, and the controlling device would control the startup of the paper number detecting device 1 when the insert detected by the insert detecting device 5 is paper.

In one embodiment of the present invention, the insert detecting device 5 is mounted at the paper inserting passage 2 and parallel to the paper number detecting device 1.

In yet another aspect, the insert detecting device 5 is an optically controlled insert detecting device.

In yet another aspect, the optically controlled insert detecting device comprises an optical emitting piece and an optical receiving piece mounted respectively and oppositely at two relatively long sides of the paper inserting passage 2.

In one embodiment of the present invention, the optical emitting piece and the optical receiving piece are mounted at the middle parts of the two relatively long sides of the paper inserting passage 2 respectively.

In one embodiment of the present invention, the optical emitting piece is an optical emitting pipe, and the optical receiving piece is an optical receiving pipe. The optical emitting pipe and the optical receiving pipe utilize the different penetration rates of the optical wave to different pieces of paper to detect the number of paper, so the optical emitting pipe is an infrared ray emitting pipe, a visible light emitting pipe or an ultraviolet ray emitting pipe, correspondingly the optical receiving pipe is an infrared ray receiving pipe, a visible light receiving pipe or an ultraviolet ray receiving pipe. The optical emitting pipe and the optical receiving pipe of the present invention and the paper inserting opening assembly 4 can be a whole part or different parts. The outer diameters of the pipes are generally 3 mm or 5 mm, and there is no limitation to their colors.

In a further aspect, the new type protection device for shredders further comprises at least one opaque shielding component 6 at the middle of which there is at least one slot 7 along the length direction, and the opaque shielding component(s) 6 is(are) mounted at the paper inserting passage 2 for shielding off beams and sundries.

In one embodiment of the present invention, the opaque shielding components 6 the number of which is 2 are mounted at two ends of the paper inserting passage 2 respectively. Thus the two-stage opaque shielding components 6 are formed, have a better shielding effect. The more the slots 7 are, the smaller the resistance force the paper received when inserted is, and at the same time the slots 7 do not affect the light shielding effect of the upper and lower opaque shielding components 6.

In one embodiment of the present invention, the number of the slot 7 in the opaque shielding component 6 is 1, two ends of the opaque shielding component 6 are separated from two relatively short sides of the paper inserting passage 2, and two sides of the opaque shielding component 6 are fixed to the two relatively long sides of the paper inserting passage 2.

In yet another aspect, the opaque shielding component 6 is a plastic film, a piece of paper, a metal sheet or a cloth strip. In one embodiment of the present invention, the opaque shielding component 6 is a thin plastic film; two-stage thin plastic films are fixed through the threaded holes in the paper inserting opening assembly 4 respectively. The thin plastic films have a certain elasticity, thus while they can achieve shield off environmental lights, shredded paper and dusts, they can also clamp the inserted paper tightly, which facilitates the shredding of paper at one hand, and develop the detecting accuracy of the paper number detecting device 1. When many pieces of paper passes through the upper and lower thin plastic films, they are clamped tightly, and shredded by the cutting blades 3 when the number of paper does not exceed the predetermined value.

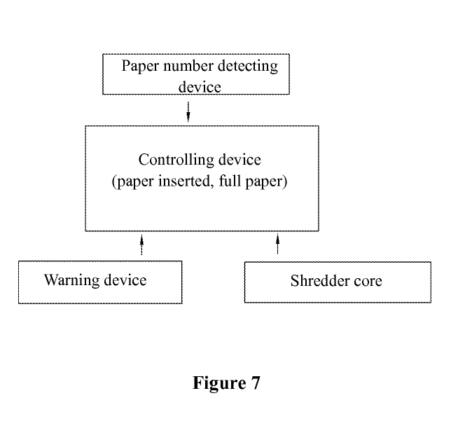

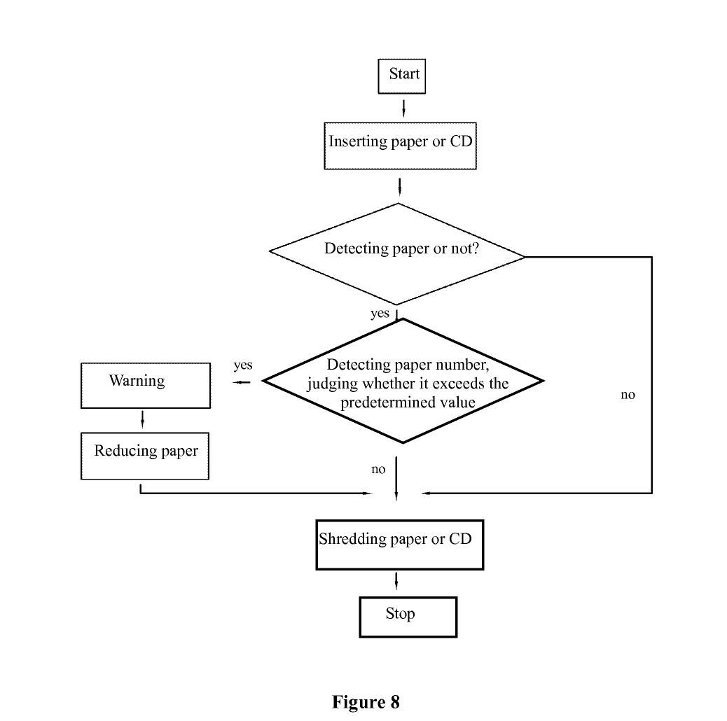

The frame chart of the circuit of the new type protection device for shredders of the present invention is shown as FIG. 7, based on the frame chart of the circuit of the protection device of common shredders, the paper number detecting device 1 is added, the insert detecting device 5 can be added when necessary, the warning device can utilize the existing indicating device of shredders, and the controlling device can be obtained by improving the existing control panel of shredders. The working process frame chart is shown as FIG. 8. That frame chart shows some functions of the paper number detecting device 1, and does not show the whole working process of the shredder main controlling circuit. The article to be shredded is inserted into the paper inserting passage 2 through the slot 7 in the opaque shielding components 6, the insert detecting device 5 at first discriminate whether the inserted article to be shredded is paper, card or CD, if it is card or CD, the controlling device would control the motor to drive the cutting blades 3 to shred it directly; if it is paper, the controlling device would control the paper number detecting device 1 to detect the number of the paper, if the number of the paper does not exceed the predetermined value, the controlling device would control the motor to drive the cutting blades 3 to shred the paper, if the number of the paper exceeds the predetermined value (for example, the predetermined value is 12, the number of the inserted paper is 5), the warning device (for example the red lamp on the upper cover lightens) would warn the user, when the user withdraws extra pieces of paper and the warning device stops warning (for example the lightened red lamp is extinguished), the controlling device would control the motor to drive the cutting blades 3 to shred the paper automatically.

To sum up, the new type protection device for shredders of the present invention controls the number of the paper to be shredded during the paper inserting stage, and shreds paper automatically only in a predetermined value range, to avoid abnormalities that result in failure of the machine such as jam and tooth breaking when the shredder is shredding many pieces of paper, so as to reduce maintenance times and cost, extend service life, and make application of shredders safer and more reliable, more convenient and simpler, then to achieve better protection of shredders.

While the present invention has been particularly shown and described with references to preferred embodiments thereof, it will be understood by those skilled in the art that various changes in form and details may be made therein without departing from the spirit and scope of the invention as defined by the claims. It is clearly understood therefore that the same is by way of illustration and example only and is not to be taken by way of limitation.

I claim:

1. A new type protection device for shredders, comprising
a paper number detecting device, mounted at the paper inserting passage of the shredder, and detecting the number of the paper inserted into the paper inserting passage;
a warning device, mounted on the shredder and warning the user;
a controlling device, in line connection with the paper number detecting device and the warning device respectively, mounted in the shredder and in line connection with the driving component of the shredder driving the shredder blades, for controlling the driving component and the warning device respectively according to the detecting result of the paper number detecting device.

2. The new type protection device for shredders according to claim 1, wherein the paper number detecting device is an optically controlled paper number detecting device.

3. The new type protection device for shredders according to claim 2, wherein the optically controlled paper number detecting device comprises an optical emitting component and an optical receiving component mounted respectively and oppositely at two relatively long sides of the paper inserting passage.

4. The new type protection device for shredders according to claim 3, wherein the optical emitting component and the optical receiving component are mounted at the middle parts of the two relatively long sides of the paper inserting passage respectively.

5. The new type protection device for shredders according to claim 3, wherein the optical emitting component is an optical emitting tube, and the optical receiving component is an optical receiving tube.

6. The new type protection device for shredders according to claim 5, wherein the optical emitting tube is an infrared ray emitting tube, a visible light emitting tube or an ultraviolet ray emitting tube, correspondingly the optical receiving tube is an infrared ray receiving tube, a visible light receiving tube or an ultraviolet ray receiving tube.

7. The new type protection device for shredders according to claim 1, wherein the control center of the shredder and the controlling device are integrated as a whole.

8. The new type protection device for shredders according to claim 1, wherein the warning device is an audible warning component or a light warning component.

9. The new type protection device for shredders according to claim 8, wherein the audible warning component is a loudspeaker, and the light warning component is a LED indicating lamp.

10. The new type protection device for shredders according to claim 1, wherein the new type protection device for shredders further comprises an insert detecting device in line connection with the controlling device and mounted at the paper inserting passage of the shredder for detecting whether an insert in the paper inserting passage is paper or not, and the controlling device would control the startup of the paper number detecting device when the insert detected by the insert detecting device is paper.

11. The new type protection device for shredders according to claim 10, wherein the insert detecting device is mounted at the paper inserting passage and parallel to the paper number detecting device.

12. The new type protection device for shredders according to claim 10, wherein the insert detecting device is an optically controlled insert detecting device.

13. The new type protection device for shredders according to claim 12, wherein the optically controlled insert detecting device comprises an optical emitting piece and an optical receiving piece mounted respectively and oppositely at two relatively long sides of the paper inserting passage.

14. The new type protection device for shredders according to claim 13, wherein the optical emitting piece and the optical receiving piece are mounted at the middle parts of the two relatively long sides of the paper inserting passage respectively.

15. The new type protection device for shredders according to claim 13, wherein the optical emitting piece is an optical emitting pipe, and the optical receiving piece is an optical receiving pipe.

16. The new type protection device for shredders according to claim 15, wherein the optical emitting pipe is an infrared ray emitting pipe, a visible light emitting pipe or an ultraviolet ray emitting pipe, correspondingly the optical receiving pipe is an infrared ray receiving pipe, a visible light receiving pipe or an ultraviolet ray receiving pipe.

17. The new type protection device for shredders according to claim 1, wherein the new type protection device for shredders further comprises at least one opaque shielding component at the middle of which there is at least one slot along the length direction, and the opaque shielding component(s) is (are) mounted at the paper inserting passage for shielding off beams and sundries.

18. The new type protection device for shredders according to claim 17, wherein the opaque shielding components the number of which is 2 are mounted at two ends of the paper inserting passage respectively.

19. The new type protection device for shredders according to claim 17, wherein the number of the slot in the opaque shielding component is 1, two ends of the opaque shielding component are separated from two relatively short sides of the paper inserting passage, and two sides of the opaque shielding component are fixed to the two relatively long sides of the paper inserting passage.

20. The new type protection device for shredders according to claim 17, wherein the opaque shielding component is a plastic film, a piece of paper, a metal sheet or a cloth strip.

21. A new type protection device for shredders, comprising:
a paper number detecting device, mounted at the paper inserting passage of the shredder, and detecting the number of the paper inserted into the paper inserting passage;
a warning device, mounted on the shredder and warning the user;
an insert detecting device, mounted at the paper inserting passage of the shredder for detecting whether an insert in the paper inserting passage is paper or not;
a controlling device, in line connection with the paper number detecting device, the warning device and the insert detecting device respectively, mounted in the shredder and in line connection with the driving component of the shredder driving the shredder blades, for controlling the startup of the paper number detecting device when the insert detected by the insert detecting device is paper, and controlling the driving component and the warning device respectively according to the detecting result of the paper number detecting device; and
at least one opaque shielding component, at the middle of which there is at least one slot along the length direction, and mounted at the paper inserting passage for shielding off beams and sundries.

22. The new type protection device for shredders according to claim 21, wherein the paper number detecting device is an optically controlled paper number detecting device.

23. The new type protection device for shredders according to claim 22, wherein the optically controlled paper number detecting device comprises an optical emitting component and an optical receiving component mounted respectively and oppositely at two relatively long sides of the paper inserting passage.

24. The new type protection device for shredders according to claim 23, wherein the optical emitting component and the optical receiving component are mounted at the middle parts of the two relatively long sides of the paper inserting passage respectively.

25. The new type protection device for shredders according to claim 23, wherein the optical emitting component is an optical emitting tube, and the optical receiving component is an optical receiving tube.

26. The new type protection device for shredders according to claim 25, wherein the optical emitting tube is an infrared ray emitting tube, a visible light emitting tube or an ultraviolet ray emitting tube, correspondingly the optical receiving tube is an infrared ray receiving tube, a visible light receiving tube or an ultraviolet ray receiving tube.

27. The new type protection device for shredders according to claim 21, wherein the control center of the shredder and the controlling device are integrated as a whole.

28. The new type protection device for shredders according to claim 21, wherein the warning device is an audible warning component or a light warning component.

29. The new type protection device for shredders according to claim 28, wherein the audible warning component is a loudspeaker, and the light warning component is a LED indicating lamp.

30. The new type protection device for shredders according to claim 21, wherein the insert detecting device is mounted at the paper inserting passage and parallel to the paper number detecting device.

31. The new type protection device for shredders according to claim 21, wherein the insert detecting device is an optically controlled insert detecting device.

32. The new type protection device for shredders according to claim 31, wherein the optically controlled insert detecting device comprises an optical emitting piece and an optical receiving piece mounted respectively and oppositely at two relatively long sides of the paper inserting passage.

33. The new type protection device for shredders according to claim 32, wherein the optical emitting piece and the optical receiving piece are mounted at the middle parts of the two relatively long sides of the paper inserting passage respectively.

34. The new type protection device for shredders according to claim 32, wherein the optical emitting piece is an optical emitting pipe, and the optical receiving piece is an optical receiving pipe.

35. The new type protection device for shredders according to claim 34, wherein the optical emitting pipe is an infrared ray emitting pipe, a visible light emitting pipe or an ultraviolet ray emitting pipe, correspondingly the optical receiving pipe is an infrared ray receiving pipe, a visible light receiving pipe or an ultraviolet ray receiving pipe.

36. The new type protection device for shredders according to claim 21, wherein the opaque shielding components the number of which is 2 are mounted at two ends of the paper inserting passage respectively.

37. The new type protection device for shredders according to claim 21, wherein the number of the slot in the opaque shielding component is 1, two ends of the opaque shielding component are separated from two relatively short sides of the paper inserting passage, and two sides of the opaque shielding component are fixed to the two relatively long sides of the paper inserting passage.

38. The new type protection device for shredders according to claim 21, wherein the opaque shielding component is a plastic film, a piece of paper, a metal sheet or a cloth strip.
